(19) United States
(12) Patent Application Publication
(10) Pub. No.: US 2025/0384237 A1
(43) Pub. Date: Dec. 18, 2025

(54) WEARABLE COUNTER DEVICE

(71) Applicant: Sara French, Haltom, TX (US)

(72) Inventor: Sara French, Haltom, TX (US)

(21) Appl. No.: 18/744,056

(22) Filed: Jun. 14, 2024

(51) Int. Cl. G06M 1/02; G06M 1/22; G06M 3/00

(52) U.S. Cl. CPC G06M 1/026; G06M 1/22; G06M 3/00

(57) ABSTRACT

A wearable counter device, including at least one of a strap and band to fit around a user's wrist, and a housing disposed on the at least one of the strap and the band, the housing including a face disposed on a front portion of the housing, a counter display unit disposed on at least a portion of the face to display numbers thereupon, and a clicking button disposed on at least a portion of the housing to increment the numbers displayed on the counter display unit in response to the clicking button being pressed.

### BACKGROUND

### 1. Field

The present general inventive concept relates generally to a counter device, and particularly, to a wearable counter device.

### 2. Description of the Related Art

Conventional time recording devices often require holding an independent accessory or a finger-controlled device, which limits one's mobility to address multitasking agendas.

This can make it especially difficult for registered behavior technicians (RBTs), who must track data while also carrying on other tasks along with direct social interactions with clients as a form of therapy.

Therefore, there is a need for a counter that allows for hands-free usage.

### SUMMARY

The present general inventive concept provides a wearable counter device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a wearable counter device, including at least one of a strap and band to fit around a user's wrist, and a housing disposed on the at least one of the strap and the band, the housing including a face disposed on a front portion of the housing, a counter display unit disposed on at least a portion of the face to display numbers thereupon, and a clicking button disposed on at least a portion of the housing to increment the numbers displayed on the counter display unit in response to the clicking button being pressed.

The clicking button may produce an audible clicking noise in response to the clicking button being pressed.

The wearable counter device may further include a time display unit disposed on at least a portion of the face to display a time.

The counter display unit may be an electronic digital display unit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates front-angled view of a wearable counter device, according to an exemplary embodiment of the present general inventive concept;

FIG. 2 illustrates front-angled view of a wearable counter device, according to another exemplary embodiment of the present general inventive concept; and

FIG. 3 illustrates front-angled view of a wearable counter device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Wearable Counter Device 100
Housing 110
Face 111
Counter display unit 112
Clicking Button 113
Battery 114
Central Processing Unit (CPU) 115
Strap 120
Adjustment Holes 121
Prong 122
Free Loop 123
Wearable Counter Device 200
Housing 210
Face 211
Counter display unit 212
Clicking Button 213
Battery 214
Central Processing Unit (CPU) 215
Strap 220
Side Release Buckle Male Portion 221
Side Release Buckle Female Portion 222
Buckle 223
Wearable Counter Device 300
Housing 310
Face 311
Counter Display Unit 312
Time Display Unit 313
Clicking Button 314
Time Adjustment Button 315
Battery 316
Central Processing Unit (CPU) 317
Band 320

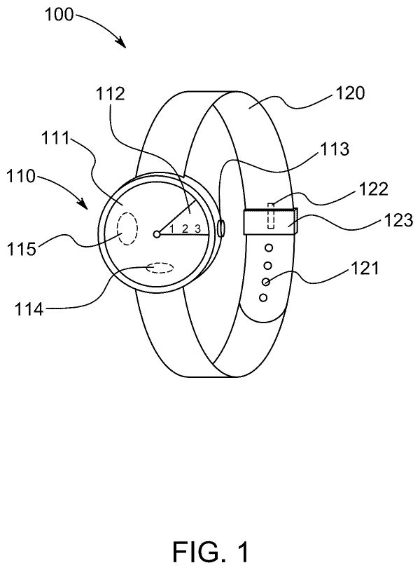

FIG. 1 illustrates front-angled view of a wearable counter device 100, according to an exemplary embodiment of the present general inventive concept.

The wearable counter device 100, and all components therein and/or connected thereto, may be constructed from at least one of metal, plastic, stone, ceramics, wood, silicone, paper, cloth, circuitry, leather, and rubber, etc., but is not limited thereto, and can be constructed from any material known to one of ordinary skill in the art.

Referring to FIG. 1, the wearable counter device 100 may include a housing 110 and a strap 120, but is not limited thereto.

The housing 110 may be permanently or removably attached to the strap 120.

Referring to FIG. 1, the housing 110 is depicted as having a circular shape, but is not limited thereto.

The housing 110 may include a face 111, a counter display unit 112, a clicking button 113, a battery 114, and a central processing unit (CPU) 115, but is not limited thereto.

The face 111 may have the counter display unit 112 disposed thereupon, such that the counter display unit 112 displays numbers thereupon.

The clicking button 113 may be disposed at a side portion of the housing 110, but is not limited thereto, and may be disposed at any portion of the housing 110 desired by a manufacturer.

The clicking button 113 may make a “clicking” noise each time it is depressed, similarly as a conventional analog clicker device.

Each time the clicking button 113 is pressed, the counter display unit 112 increments a number by one.

If the clicking button 113 is held down for a period of 3 seconds, for example, the counter display unit 112 resets back to zero (0).

The battery 114 and the CPU 115 may be disposed within the housing 110.

The battery 114 may be connected to the counter display unit 112, the clicking button 113, and the CPU 115 to provide electrical power thereto.

The CPU 115 may include electronic circuitry to carry out instructions of a computer program by performing basic arithmetic, logical, control and input/output (I/O) operations specified by the instructions. The CPU 115 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 115 may also include a microprocessor and a microcontroller. The transmitter CPU 115 may be a local computer device, a remote server, or cloud computing device.

The CPU 115 may also include a storage unit, a random access memory (RAM), a read-only memory (ROM), a hard disk, a flash drive, a database connected to the Internet, cloud-based storage, Internet-based storage, or any other type of storage unit.

The CPU 115 may access the Internet via an internal communication unit to allow the CPU 115 to access a website, and/or may allow for communication with a mobile application and/or a software application. For ease of description, the mobile and/or the software application will be hereinafter referred to as an app. The app may be downloaded from the Internet to be stored on the storage unit of the CPU 115.

The CPU 115 may also have a global positioning service (GPS) device installed therein, to allow the CPU 115 to be located via a GPS signal.

Thus, the CPU 115 may provide communication between the clicking button 113 and the counter display unit 112, such that the CPU 115 instructs the counter display unit 112 to increment a number displayed on the counter display unit 112 by one in response to a pressing of the clicking button 113.

For example, is the counter display unit 112 is currently displaying the number zero (0), pressing the clicking button 113 five times produces five audible “clicks”, and simultaneously also causes the counter display unit 112 to increment one-by-one to the number five (5).

The counter display unit 112 may be analog or digital, based on a manufacturer's preference.

If the counter display unit 112 is analog, then the counter display unit 112 may be a rolling number incrementor, similarly to conventional clicking-counters.

If the counter display unit 112 is digital, then the counter display unit 112 may be a digital screen that displays digital numbers electronically thereupon.

The strap 120 may include a plurality of adjustment holes 121, a prong 122, and a free loop 123, but is not limited thereto.

The strap 120 may be adjusted to fit a user's wrist, similarly to a regular wristwatch. For example, the prong 122 may fit inside one of the plurality of adjustment holes 121 to allow the strap to be secured at a certain point, such that the strap 120 does not expand to contract.

A portion of the strap 120 may be threaded through the free loop 123 in order to prevent the portion of the strap 120 from hanging and/or bothering the user.

Accordingly, the wearable counter device 100 may allow the user to wear the housing 110 including the counter display unit 112 on a wrist of the user, thereby freeing up the user's hands while still having the convenience of a useful counter device within reach.

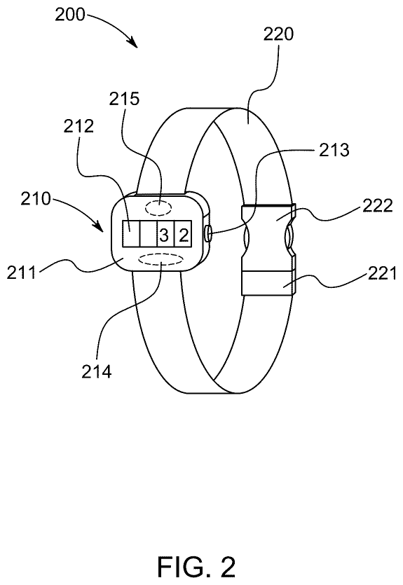

FIG. 2 illustrates front-angled view of a wearable counter device 200, according to another exemplary embodiment of the present general inventive concept.

The wearable counter device 200, and all components therein and/or connected thereto, may be constructed from at least one of metal, plastic, stone, ceramics, wood, silicone, paper, cloth, circuitry, leather, and rubber, etc., but is not limited thereto, and can be constructed from any material known to one of ordinary skill in the art.

Referring to FIG. 2, the wearable counter device 200 may include a housing 210 and a strap 220, but is not limited thereto.

The housing 210 may be permanently or removably attached to the strap 220.

Referring to FIG. 2, the housing 210 is depicted as having a rectangular shape, but is not limited thereto.

The housing 210 may include a face 211, a counter display unit 212, a clicking button 213, a battery 214, and a central processing unit (CPU) 215, but is not limited thereto.

The face 211 may have the counter display unit 212 disposed thereupon, such that the counter display unit 212 displays numbers thereupon.

The clicking button 213 may be disposed at a side portion of the housing 210, but is not limited thereto, and may be disposed at any portion of the housing 210 desired by a manufacturer.

The clicking button 213 may make an audible “clicking” noise each time it is depressed, similarly as a conventional analog clicker device.

Each time the clicking button 213 is pressed, the counter display unit 212 increments a number by one.

If the clicking button 213 is held down for a period of 3 seconds, for example, the counter display unit 212 resets back to zero (0).

The battery 214 and the CPU 215 may be disposed within the housing 210.

The battery 214 may be connected to the counter display unit 212, the clicking button 213, and the CPU 215 to provide electrical power thereto.

The CPU 215 may include electronic circuitry to carry out instructions of a computer program by performing basic arithmetic, logical, control and input/output (I/O) operations specified by the instructions. The CPU 215 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 215 may also include a microprocessor and a microcontroller. The transmitter CPU 215 may be a local computer device, a remote server, or cloud computing device.

The CPU 215 may also include a storage unit, a random access memory (RAM), a read-only memory (ROM), a hard disk, a flash drive, a database connected to the Internet, cloud-based storage, Internet-based storage, or any other type of storage unit.

The CPU 215 may access the Internet via an internal communication unit to allow the CPU 215 to access a website, and/or may allow for communication with a mobile application and/or a software application. For ease of description, the mobile and/or the software application will be hereinafter referred to as an app. The app may be downloaded from the Internet to be stored on the storage unit of the CPU 215.

The CPU 215 may also have a global positioning service (GPS) device installed therein, to allow the CPU 215 to be located via a GPS signal.

Thus, the CPU 215 may provide communication between the clicking button 213 and the counter display unit 212, such that the CPU 215 instructs the counter display unit 212 to increment a number displayed on the counter display unit 212 by one in response to a pressing of the clicking button 213.

For example, is the counter display unit 212 is currently displaying the number zero (0), pressing the clicking button 213 five times produces five audible “clicks”, and simultaneously also causes the counter display unit 212 to increment one-by-one to the number five (5).

The counter display unit 212 may be analog or digital, based on a manufacturer's preference.

If the counter display unit 212 is analog, then the counter display unit 212 may be a rolling number incrementor, similarly to conventional clicking-counters.

If the counter display unit 212 is digital, then the counter display unit 212 may be a digital screen that displays digital numbers electronically thereupon.

The strap 220 may include a side release buckle male portion 221 and a side release buckle female portion 222, but is not limited thereto.

The strap 220 may be adjusted to fit a user's wrist. A portion of the side release buckle male portion 221 may fit into the side release buckle female portion 222 in order to secure the strap 220 around a user's wrist.

Accordingly, the wearable counter device 200 may allow the user to wear the housing 210 including the counter display unit 212 on a wrist of the user, thereby freeing up the user's hands while still having the convenience of a useful counter device within reach.

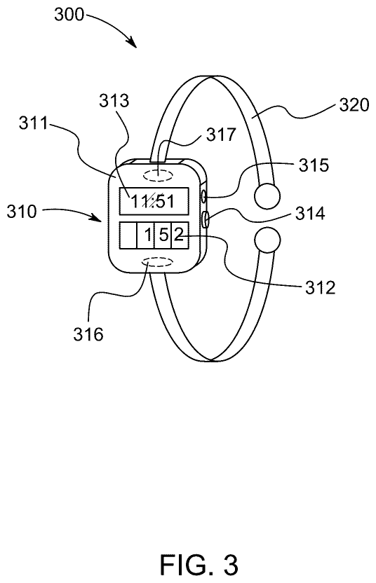

FIG. 3 illustrates front-angled view of a wearable counter device 300, according to an exemplary embodiment of the present general inventive concept.

The wearable counter device 300, and all components therein and/or connected thereto, may be constructed from at least one of metal, plastic, stone, ceramics, wood, silicone, paper, cloth, circuitry, leather, and rubber, etc., but is not limited thereto, and can be constructed from any material known to one of ordinary skill in the art.

Referring to FIG. 3, the wearable counter device 300 may include a housing 310 and a strap 320, but is not limited thereto.

The housing 310 may be permanently or removably attached to the strap 220.

Referring to FIG. 3, the housing 310 is depicted as having a rectangular shape, but is not limited thereto.

The housing 310 may include a face 311, a counter display unit 312, a time display unit 313, a clicking button 314, a time adjustment button 315, a battery 316, and a central processing unit (CPU) 317, but is not limited thereto.

The face 311 may have the counter display unit 312 and the time display unit 313 disposed thereupon, such that the counter display unit 312 displays numbers thereupon, and the time display unit 313 displays a time thereupon.

The clicking button 314 and the time adjustment button 315 may be disposed at a side portion of the housing 310, but is not limited thereto, and may be disposed at any portion of the housing 310 desired by a manufacturer.

The clicking button 314 may make an audible “clicking” noise each time it is depressed, similarly as a conventional analog clicker device.

Each time the clicking button 314 is pressed, the counter display unit 312 increments a number by one.

If the clicking button 314 is held down for a period of 3 seconds, for example, the counter display unit 312 resets back to zero (0).

The time adjustment button 315 may be pressed to adjust the time displayed on the time display unit 313.

The battery 316 and the CPU 317 may be disposed within the housing 310.

The battery 316 may be connected to the counter display unit 312, the clicking button 314, and the CPU 317 to provide electrical power thereto.

The CPU 317 may include electronic circuitry to carry out instructions of a computer program by performing basic arithmetic, logical, control and input/output (I/O) operations specified by the instructions. The CPU 317 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 317 may also include a microprocessor and a microcontroller. The transmitter CPU 317 may be a local computer device, a remote server, or cloud computing device.

The CPU 317 may also include a storage unit, a random access memory (RAM), a read-only memory (ROM), a hard disk, a flash drive, a database connected to the Internet, cloud-based storage, Internet-based storage, or any other type of storage unit.

The CPU 317 may access the Internet via an internal communication unit to allow the CPU 317 to access a website, and/or may allow for communication with a mobile application and/or a software application. For ease of description, the mobile and/or the software application will be hereinafter referred to as an app. The app may be downloaded from the Internet to be stored on the storage unit of the CPU 317.

The CPU 317 may also have a global positioning service (GPS) device installed therein, to allow the CPU 317 to be located via a GPS signal.

Thus, the CPU 317 may provide communication between the clicking button 314 and the counter display unit 312, such that the CPU 215 instructs the counter display unit 312 to increment a number displayed on the counter display unit 212 by one in response to a pressing of the clicking button 314.

For example, is the counter display unit 312 is currently displaying the number zero (0), pressing the clicking button 314 five times produces five audible “clicks”, and simultaneously also causes the counter display unit 312 to increment one-by-one to the number five (5).

The counter display unit 312 may be analog or digital, based on a manufacturer's preference.

If the counter display unit 312 is analog, then the counter display unit 312 may be a rolling number incrementor, similarly to conventional clicking-counters.

If the counter display unit 312 is digital, then the counter display unit 312 may be a digital screen that displays digital numbers electronically thereupon.

The band 320 may be adjusted to fit a user's wrist by pulling or squeezing the band 320 in order to expand or contract a size of the band 320.

Accordingly, the wearable counter device 300 may allow the user to wear the housing 310 including the counter display unit 312 on a wrist of the user, thereby freeing up the user's hands while still having the convenience of a useful counter device within reach.

It is noteworthy that any of the components described with reference to FIGS. 1, 2, and 3 may be interchanged, such that the band 330, example, may be utilized with the housing 100. Therefore, all of the embodiments of FIGS. 1, 2, and 3 and components thereof may be interchangeable.

The present general inventive concept may include a wearable counter device 100, including at least one of a strap 120 and band 320 to fit around a user's wrist, and a housing 110 disposed on the at least one of the strap 120 and the band 320, the housing 110 including a face 111 disposed on a front portion of the housing 110, a counter display unit 112 disposed on at least a portion of the face 111 to display numbers thereupon, and a clicking button 113 disposed on at least a portion of the housing 110 to increment the numbers displayed on the counter display unit 112 in response to the clicking button 113 being pressed.

The clicking button 113 may produce an audible clicking noise in response to the clicking button 113 being pressed.

The wearable counter device 100 may further include a time display unit 313 disposed on at least a portion of the face 111 to display a time.

The counter display unit 112 may be an electronic digital display unit.

A main purpose of the present general inventive concept is to provide users with a wearable counter designed to facilitate data tracking. Ingenious and practical, the present general inventive concept offers a modern accessory that can be worn on the wrist, eliminating the need to carry a handheld clicker, and therefore freeing a professional to conduct other tasks. Expanding on the initial design of an average bracelet, the present general inventive concept introduces a novel hands-free analog or digital counter that permits users to perform various tasks while seamlessly tracking data without interruption. With a simple button mechanism for control and designed with an easy-to-read face, the present general inventive concept enables individuals to track data effortlessly with each click. Unlike handheld clickers that can be misplaced or cumbersome to carry, this wrist-worn counter simplifies data tracking by offering a centralized, always-accessible solution. Moreover, its reset mechanism ensures accuracy and precision in recordings to ensure engagements are timed, for tracking performance metrics. This innovative, top-quality device combines functionality, convenience, and style to provide users with a seamless way to keep track of data without the need for a handheld clicker. As a result, the present general inventive concept may prove to be essential in the apparel/accessories and medical industry.

The present general inventive concept is the only product of its kind that transforms the traditional clicker into a wrist-worn tool for quick and convenient data tracking. This unprecedented product is uniquely designed with sound to simplify the count-clicking process, a comfortable band that comes in a wide variety of different colors and designs to appeal to consumers, and is defined by a practicing RBT who can easily see the usefulness of this accessory in their field.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A wearable counter device, comprising:
at least one of a strap and band to fit around a user's wrist; and
a housing disposed on the at least one of the strap and the band, the housing comprising:
a face disposed on a front portion of the housing,
a counter display unit disposed on at least a portion of the face to display numbers thereupon, and
a clicking button disposed on at least a portion of the housing to increment the numbers displayed on the counter display unit in response to the clicking button being pressed.

2. The wearable counter device of claim 1, wherein the clicking button produces an audible clicking noise in response to the clicking button being pressed.

3. The wearable counter device of claim 1, further comprising:
a time display unit disposed on at least a portion of the face to display a time.

4. The wearable counter device of claim 1, wherein the counter display unit is an electronic digital display unit.
